(19) United States
(12) Patent Application Publication
(10) Pub. No.: US 2019/0389305 A1
(43) Pub. Date: Dec. 26, 2019

(54) CONTROL DEVICE OF FOUR-WHEEL DRIVE VEHICLE

(71) Applicant: TOYOTA JIDOSHA KABUSHIKI KAISHA, Toyota-shi (JP)

(72) Inventor: Satoshi SHIMIZU, Seto-shi (JP)

(73) Assignee: TOYOTA JIDOSHA KABUSHIKI KAISHA, Toyota-shi (JP)

(21) Appl. No.: 16/451,622

(22) Filed: Jun. 25, 2019

(30) Foreign Application Priority Data
Jun. 25, 2018 (JP) 2018-120279

(51) Int. Cl. B60K 23/08; B60K 6/52; B60T 8/32; B60T 8/176

(52) U.S. Cl. CPC B60K 23/08; B60T 8/176; B60T 8/32; B60K 6/52

(57) ABSTRACT

A control device of a four-wheel drive vehicle that includes a central axle disposed between paired left and right control couplings and coupled to the paired control couplings and that is switched between a two-wheel drive state and a four-wheel drive state selects between provision and stop of a slip prevention control in which when at least one of the main drive wheel slips during running of the vehicle, a brake is automatically operated to the at least one slipping main drive wheel, and when the stop of the slip prevention control is selected and it is detected that the at least one main drive wheel has slipped in the four-wheel drive state, a rotation speed of the central axle is made lower than that at the time of detection of the slip of the at least one main drive wheel.

The disclosure of Japanese Patent Application No. 2018-120279 filed on Jun. 25, 2018 including the specification, drawings and abstract is incorporated herein by reference in its entirety.

### FIELD OF THE INVENTION

The present invention relates to a technique in a four-wheel drive vehicle transmitting a drive power from a drive power source to a left-and-right pair of main drive wheels and a left-and-right pair of sub-drive wheels, for suppressing overheating of control couplings disposed on the sub-drive wheels when at least one main drive wheel of main drive wheels slips.

### DESCRIPTION OF THE RELATED ART

There is known a four-wheel drive vehicle that includes a central axle disposed between paired left and right control couplings and coupled to the paired control couplings and that is switched between a two-wheel drive state in which a drive power is transmitted from a drive power source via a differential device to a left-and-right pair of main drive wheels and a four-wheel drive state in which the drive power is also transmitted from the drive power source via the central axle and the paired control couplings to a left-and-right pair of sub-drive wheels in addition to the main drive wheels. For example, this corresponds to the four-wheel drive vehicle described in Patent Document 1. In the four-wheel drive vehicle of Patent Document 1, a fastening power of respective one of the paired control couplings is changed to vary torque distributed to respective one of the left-and-right pair of sub-drive wheels (rear wheels). It is described that in the four-wheel drive vehicle of Patent Document 1, if the vehicle is determined as being in a slip stop state, i.e. a stop state in which at least one of wheel speeds of left, right, front, and rear wheels is lower than a predetermined speed defined in advance as a stop determination speed, the fastening powers of the paired control couplings are corrected. Therefore, when at least one of the front wheels serving as the main drive wheels slips, the torque distributed to the rear wheels serving as the sub-drive wheels increases.

### PRIOR ART DOCUMENT

### Patent Document

Patent Document 1: Japanese Laid-Open Patent Publication No. 2006-56444

### SUMMARY OF THE INVENTION

### Technical Problem

Four-wheel drive vehicles as described in Patent Document 1 include a four-wheel drive vehicle allowing a driver etc. to select between provision and stop of a slip prevention control in which when at least one main drive wheel slips during running of the vehicle, a brake is automatically operated to the at least one slipping main drive wheel of the main drive wheels. In such a four-wheel drive vehicle, when the stop of the slip prevention control is selected and the at least one main drive wheel slips due to running on a low μ road having a road surface with a relatively low friction coefficient (μ), the drive power is not transmitted froth the drive power source to the left-and-right pair of main drive wheels, and a large portion of the drive power is transmitted from the drive power source to the left-and-right pair of sub-drive wheels, so that an input-side friction member and an output-side friction member slip in the paired control couplings. Therefore, the vehicle has a problem that the control couplings are overheated due to a friction heat generated between the friction members of the control couplings.

The present invention was conceived in view of the situations and it is therefore an object of the present invention to provide a control device of a four-wheel drive vehicle configured to suppress overheating of a control coupling when at least one main drive wheel slips.

### Solution to Problem

To achieve the above object, a first aspect of the present invention provides a control device of a four-wheel drive vehicle that (a) includes a central axle disposed between paired left and right control couplings and coupled to the paired control couplings and that is switched between a two-wheel drive state in which a drive power is transmitted from a drive power source via a differential device to a left-and-right pair of main drive wheels and a four-wheel drive state in which the drive power is also transmitted from the drive power source via the central axle and the paired control couplings to a left-and-right pair of sub-drive wheels, wherein (b) the control device selects between provision and stop of a slip prevention control in which when at least one main drive wheel of the left-and-right pair of main drive wheels slips during running of the vehicle, a brake is automatically operated to the at least one slipping main drive wheel, and wherein (c) when the stop of the slip prevention control is selected and it is detected that the at least one main drive wheel of the left-and-right pair of main drive wheels has slipped in the four-wheel drive state, a rotation speed of the central axle is made lower than the rotation speed of the central axle at the time of detection of the slip of the at least one main drive wheel.

### Advantageous Effects of Invention

According to the first aspect of the invention, when the stop of the slip prevention control is selected, and it is detected that the at least one of the left-and-right pair of main drive wheels has slipped in the four-wheel drive state, the control device makes the rotation speed of the central axle lower than the rotation speed of the central axle at the time of detection of the slip of the at least one main drive wheels. Therefore, the rotation speeds of the input-side friction members are reduced in the control couplings, and respective differential rotation speeds become smaller between the input-side friction members and the output-side friction members in the control couplings, so that the control couplings can be prevented from overheating.

### BRIEF DESCRIPTION OF DRAWINGS

FIG. 1 is a schematic for schematically explaining a configuration of a four-wheel drive vehicle to which the present invention is preferably applied.

FIG. 2 is a functional block diagram for explaining main portions of a control function of an electronic control device of the four-wheel drive vehicle of FIG. 1.

FIG. 3 is a diagram showing a state in which a left-side front wheel and a left-side rear wheel slip when the vehicle starts on a road surface having different friction coefficients between the left and right sides in a four-wheel drive state of the four-wheel drive vehicle of FIG. 1, where a road on the left side of the vehicle has a relatively low friction coefficient μ on the road surface.

FIG. 4 is a flowchart for explaining an example of operation of a braking device and a left-and-right pair of control couplings in the four-wheel drive state in the electronic control device of FIG. 1 while both the left-side front wheel and the left-side rear wheel are slipping.

FIG. 5 is a diagram showing another example, i.e., a second example, of the present invention and is a functional block diagram for explaining main portions of a control function of an electronic control device of the four-wheel drive vehicle.

FIG. 6 is a flowchart for explaining an example of operation of the braking device, the left-and-right pair of control couplings, and an engine in the four-wheel drive state in the electronic control device of FIG. 5 while both the left-side front wheel and the left-side rear wheel are slipping.

FIG. 7 is a diagram showing still another example, i.e., a third example, of the present invention and is a functional block diagram for explaining main portions of a control function of an electronic control device of the four-wheel drive vehicle.

FIG. 8 is a flowchart for explaining an example of operation of the left-and-right pair of control couplings, and the engine in the four-wheel drive state in the electronic control device of FIG. 7 while both the left-side front wheel and the left-side rear wheel are slipping.

FIG. 9 is a diagram showing still another example, i.e., a fourth example, of the present invention and is a functional block diagram for explaining main portions of a control function of an electronic control device of the four-wheel drive vehicle.

FIG. 10 is a flowchart for explaining an example of operation of the braking device, the left-and-right pair of control couplings, and first and second clutches in the four-wheel drive state in the electronic control device while both the left-side front wheel and the left-side rear wheel are slipping.

FIG. 11 is a diagram showing still another example, i.e., a fifth example, of the present invention and is a functional block diagram for explaining main portions of a control function of an electronic control device of the four-wheel drive vehicle.

FIG. 12 is a flowchart for explaining an example of operation of the left-and-right pair of control couplings and the first and second clutches in the four-wheel drive state in the electronic control device of FIG. 11 while both the left-side front wheel and the left-side rear wheel are slipping.

FIG. 13 is a diagram showing still another example, i.e., a sixth example, of the present invention and is a functional block diagram for explaining main portions of a control function of an electronic control device of the four-wheel drive vehicle.

FIG. 14 is a flowchart for explaining an example of operation of the left-and-right pair of control couplings and an automatic transmission in the four-wheel drive state in the electronic control device of FIG. 13 while both the left-side front wheel and the left-side rear wheel are slipping.

### MODES FOR CARRYING OUT THE INVENTION

A second aspect of the present invention provides the control device of a four-wheel drive vehicle recited in the first aspect of the invention, wherein when the stop of the slip prevention control is selected and it is detected that the at least one main drive wheel has slipped in the four-wheel drive state, the brake is operated to the at least one slipping main drive wheel to reduce the rotation speed of the central axle. Therefore, the rotation speed of the central axle is made lower than the rotation speed of the central axle at the time of detection of the slip of the main drive wheel. Additionally, for example, when one of the left-and-right pair of main drive wheels slips and the brake is operated to the slipping main drive wheel, the slipping main drive wheel is braked, and the drive power is transmitted to the non-slipping main drive wheel by the differential device, so that the drive power for starting the vehicle can suitably be ensured.

A third aspect of the present invention provides the control device of a four-wheel drive vehicle recited in the first or second aspect of the invention, wherein when the stop of the slip prevention control is selected and it is detected that the at least one main drive wheel has slipped in the four-wheel drive state, the drive power output from the drive power source is reduced as compared to the drive power at the time of detection of the slip of the at least one main drive wheel to reduce the rotation speed of the central axle. Therefore, the rotation speed of the central axle is made lower than the rotation speed of the central axle at the time of detection of the slip of the main drive wheel, so that the control couplings can be prevented from overheating.

A fourth aspect of the present invention provides the control device of a four-wheel drive vehicle recited in the first or second aspect of the invention, wherein (a) the vehicle includes a power transmitting member transmitting the drive power output from the drive power source to the central axle in the four-wheel drive state, a first clutch selectively disconnecting or connecting a power transmission path between the drive power source and the power transmitting member, and a second clutch selectively disconnecting or connecting a power transmission path between the power transmitting member and the central axle, and wherein (b) when the stop of the slip prevention control is selected and it is detected that the at least one main drive wheel of the left-and-right pair of main drive wheels has slipped in the four-wheel drive state, at least one of the first clutch and the second clutch is released to reduce the rotation speed of the central axle. Therefore, at least one of the first clutch and the second clutch is released, and the power transmission path between the drive power source and the central axle is disconnected, so that the rotation speed of the central axle is made lower than the rotation speed of the central axle at the time of detection of the slip of the main drive wheel.

A fifth aspect of the present invention provides the control device of a four-wheel drive vehicle recited in the first aspect of the invention, wherein (a) the vehicle includes an automatic transmission in a power transmission path between the drive power source and the left-and-right pair of main drive wheels as well as between the drive power source and the central axle, and wherein (b) when the stop of the slip prevention control is selected and it is detected that the at least one main drive wheel has slipped in the four-wheel drive state, the automatic transmission is brought into a neutral state to reduce the rotation speed of the central axle. Therefore, the automatic transmission is brought into the neutral state, and the respective power transmission paths are disconnected between the drive power source and the left-and-right pair of main drive wheels and between the drive power source and the central axle, so that the rotation speed of the central axle is made lower than the rotation speed of the central axle at the time of detection of the slip of the main drive wheel.

A sixth aspect of the present invention provides the control device of a four-wheel drive vehicle recited in the first aspect of the invention, wherein when the stop of the slip prevention control is selected and it is detected that the at least one main drive wheel has slipped in the four-wheel drive state, the brake is operated to the at least one slipping main drive wheel to increase a fastening power of at least one of the control couplings depending on an intensity of the brake. Therefore, the drive power is transmitted from the drive power source to the non-slipping main drive wheel so that the drive power transmitted to the sub-drive wheels is reduced, while the fastening powers of the control couplings respectively are no longer increased regardless of the intensity of the brake, so that the control couplings can suitably be prevented from being overheated.

An example of the present invention will now be described in detail with reference to the drawings.

### FIRST EXAMPLE

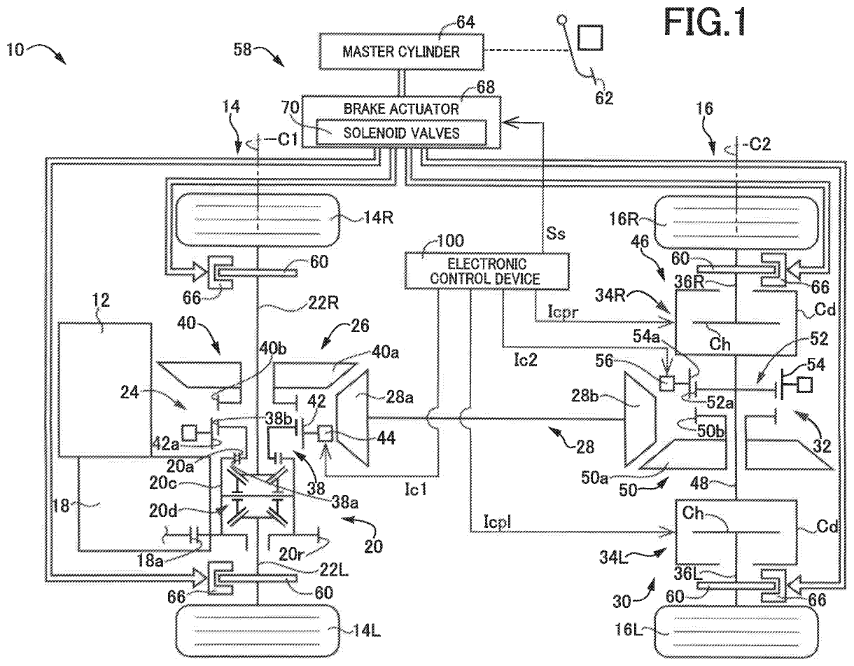

FIG. 1 is a schematic for schematically explaining a configuration of a four-wheel drive vehicle 10 to which the present invention is preferably applied. In FIG. 1, the four-wheel drive vehicle 10 uses an engine 12 as a drive power source and has an FF-based four-wheel drive device including a first power transmission path transmitting a drive power (drive torque) of the engine 12 to a pair of left-side and right-side front wheels 14L, 14R (referred to as front wheels 14 if the pair of left-side and right-side front wheels 14L, 14R is not particularly distinguished) corresponding to main drive wheels and a second power transmission path transmitting the drive power of the engine 12 to a pair of left-side and right-side rear wheels 16L, 16R (referred to as rear wheels 16 if the pair of left-side and right-side rear wheels 16L, 16R is not particularly distinguished) corresponding to sub-drive wheels. In a two-wheel drive state of the four-wheel drive vehicle 10, the drive power transmitted from the engine 12 via dais automatic transmission 18 is transmitted through a front-wheel drive power distributing unit 20 serving as a differential device and left and right front wheel axles 22L, 22R to the left-side and right-side front wheels 14L, 14R. In this two-wheel drive state, at least a first clutch 24 is released, and the drive power is not transmitted to a transfer 26, a propeller shaft (power transmitting member) 28, a rear-wheel drive power distributing unit 30, and the rear wheels 16. However, in a four-wheel drive state of the vehicle 10, the first clutch 24 and a second clutch 32 are both engaged, and a left control coupling (control coupling) 34L controls a transmission torque from a central axle 48 to the left-side rear wheel 16L, while a right control coupling (control coupling) 34R controls a transmission torque from the central axle 48 to the right-side rear wheel 16R.

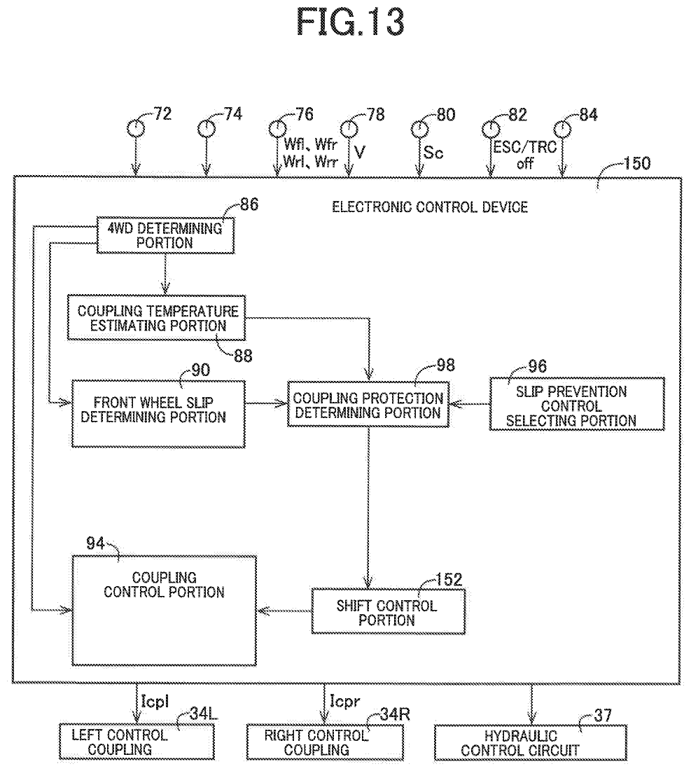

The automatic transmission 18 is a known planetary gear type automatic transmission. The automatic transmission 18 includes, for example, a plurality of planetary gear devices, and a plurality of hydraulic friction engagement devices (hereinafter referred to as engagement devices CB) such as clutches and brakes. The engagement devices CB respectively have torque capacities changed in accordance with engagement hydraulic pressures regulated by and output from solenoid valves etc. in a hydraulic control circuit 37 (see FIG. 13) included in the four-wheel drive vehicle 10, so that operation states such as engaged and released states of the engagement devices CB are switched. In the automatic transmission 18, any one of a plurality of gear shift positions (gear positions) different in speed change ratio (gear ratio) e (=transmission input rotation speed Ni/transmission output rotation speed No) is formed in accordance with engagement of a predetermined engagement device included in the engagement devices CB. In the automatic transmission 18, the operation states of the engagement devices CB are controlled by an electronic control device (control device) 100 described later in accordance with a driver's accelerator operation, a vehicle speed V, etc., so that the plurality of gear positions are selectively formed. When the engagement devices CB are all released, the automatic transmission 18 is brought into a neutral state in which no gear position is formed, i.e., power transmission is interrupted. As shown in FIG. 1, the automatic transmission 18 is included in a power transmission path between the engine 12 and the left-side and right-side front wheels 14L, 14R as well as between the engine 12 and the central axle 48 described later.

As shown in FIG. 1, the front-wheel drive power distributing unit 20 is a differential device and includes a ring gear 20r disposed rotatably around a first rotation axis C1 and meshed with an output gear 18a of the automatic transmission 18, a differential casing 20c to which the ring gear 20r is fixed, and a differential gear mechanism 20d housed in the differential casing 20c. The front-wheel drive power distributing unit 20 transmits the drive power from the engine 12 to the left and right front wheel axles 22L, 22R while allowing a differential rotation between the left and right front wheel axles 22L, 22R. The transfer 26 is provided with a first rotating member 38, and outer circumferential meshing teeth 38a are formed on an end portion of the first rotating member 38 on the left-side front wheel 14L side. The differential casing 20c is provided with inner circumferential meshing teeth 20a meshed with the outer circumferential meshing teeth 38a.

As shown in FIG. 1, the transfer 26 includes the first rotating member 38 described above, a second rotating member 40 on which a ring gear 40a is formed, and the first clutch 24 selectively connecting and disconnecting the first rotating member 38 to and from the second rotating member 40. When the first rotating member 38 and the second rotating member 40 are connected by the first clutch 24 in a power transmittable manner, the transfer 26 transmits a portion of the drive power output from the engine 12 to the rear wheels 16, i.e., the propeller shaft 28. The first clutch 24 is a meshing type dog clutch selectively disconnecting or connecting the engine 12 from or to the propeller shaft 28. The ring gear 40a is meshed with a driven pinion 28a formed on an end portion of the propeller shaft 28 on the front wheel 14 side.

As shown in FIG. 1, the first clutch 24 includes first clutch teeth 38b formed on an end portion of the first rotating member 38 on the right-side front wheel 14R side, second clutch teeth 40b formed on an end portion of the second rotating member 40 on the left-side front wheel 14L side, a first movable sleeve 42 provided with inner circumferential teeth 42a, and a first actuator 44 moving the first movable sleeve 42 in a first rotation axis C1 direction to a first meshing position at which the inner circumferential teeth 42a are meshed with the second clutch teeth 40b and a first non-meshing position at which the inner circumferential teeth 42a are not meshed with the second clutch teeth 40b. The first actuator 44 selectively moves the first movable sleeve 42 to the first meshing position and the first non-meshing position in accordance with a first clutch drive current Ic1 supplied from the electronic control device 100. The inner circumferential teeth 42a of the first movable sleeve 42 are always meshed and selectively meshed with the second clutch teeth 40b as the first clutch teeth 38b move in the first rotation axis C1 direction.

As shown in FIG. 1, the rear-wheel drive power distributing unit 30 includes a differential mechanism 46 transmitting to the left-side rear wheel 16L and the right-side rear wheel 16R the drive power distributed to the propeller shaft 28 while allowing a differential rotation of left and right rear wheel axles 36L, 36R, and the second clutch 32 selectively connecting and disconnecting the differential mechanism 46 to and from the propeller shaft 28.

As shown in FIG. 1, the differential mechanism 46 has the left control coupling 34L adjusting the drive power transmitted to the left-side rear wheel 16L, the right control coupling 34R adjusting the drive power transmitted to the right-side rear wheel 16R, and the shaft-shaped central axle 48 disposed between the left control coupling 34L and the right control coupling 34R and coupled to the left control coupling 34L and the right control coupling 34R. Although not shown, the left control coupling 34L and the right control coupling 34R are electromagnetic couplings each including an electrically controllable actuator including an electromagnetic coil and a ball cam, and a wet multiplate clutch having a frictional force, i.e., a fastening power, between an input-side friction member (not shown) disposed on a clutch drum Cd and an output-side friction member (not shown) disposed on a clutch hub Ch adjusted by the actuator. In the left control coupling 34L and the right control coupling 34R, the fastening power between the input-side friction member and the output-side friction member is increased, and the drive power, i.e., the drive torque, transmitted to the left-side rear wheel 16L and the right-side rear wheel 16R is adjusted, by magnetic forces generated by a left coupling drive current Icpl and a right coupling drive current Icpr supplied from the electronic control device 100 to the electromagnetic coils. The clutch drums Cd respectively disposed on the left control coupling 34L and the right control coupling 34R are each coupled to the central axle 48 in a power transmittable manner. The clutch hub Ch disposed on the left control coupling 34L is coupled via the rear wheel axle 36L to the left-side rear wheel 16L in a power transmittable manner, and the clutch hub Ch disposed on the right control coupling 34R is coupled via the rear wheel axle 36R to the right-side rear wheel 16R in a power transmittable manner.

As shown in FIG. 1, the rear-wheel drive power distributing unit 30 includes a first rotating member 50 rotatably disposed around a second rotation axis C2 and coupled to the propeller shaft 28 in a power transmittable manner, and a second rotating member 52 rotatably disposed around the second rotation axis C2 and integrally fixed to the central axle 48. The second clutch 32 is a meshing type dog clutch selectively disconnecting or connecting a power transmission path between the first rotating member 50 and the second rotating member 52, i.e., a power transmission path between the propeller shaft 28 and the central axle 48. An end portion of the first rotating member 50 on the left-side rear wheel 16L side is provided with a ring gear 50a meshed with a drive pinion 28b formed on an end portion of the propeller shaft 28 on the rear wheel 16 side. The propeller shaft 28 is a power transmitting member transmitting the drive power output from the engine 12 to the central axle 48 in the four-wheel drive state, i.e., in the state in which the first clutch 24 and the second clutch 32 are respectively engaged.

As shown in FIG. 1, the second clutch 32 includes first clutch teeth 50b formed on an end portion of the first rotating member 50 on the right-side rear wheel 16R side, second clutch teeth 52a formed on the second rotating member 52, a second movable sleeve 54 provided with inner circumferential teeth 54a, and a second actuator 56 moving the second movable sleeve 54 in a second rotation axis C2 direction to a second meshing position at which the inner circumferential teeth 54a are meshed with the first clutch teeth 50b and a second non-meshing position at which the inner circumferential teeth 54a are not meshed with the first clutch teeth 50b. The second actuator 56 selectively moves the second movable sleeve 54 to the second meshing position and the second non-meshing position in accordance with a second clutch drive current Ic2 supplied from the electronic control device 100. The inner circumferential teeth 54a of the second movable sleeve 54 are always meshed and selectively meshed with the first clutch teeth 50b as the second clutch teeth 52a move in the second rotation axis C2 direction.

In the four-wheel drive vehicle 10 configured as described above, for example, when a four-wheel drive running mode is selected by the electronic control device 100, the first clutch 24, the second clutch 32, the left control coupling 34L, and the right control coupling 34R are respectively engaged. This leads to formation of the four-wheel drive state in which the drive power is transmitted from the engine 12 via the front-wheel drive power distributing unit 20 etc. to the left-side and right-side front wheels 141, 14R while the drive power is also transmitted from the engine 12 via the central axle 48 and the left and right control couplings 34L, 34R to the left-side and right-side rear wheels 16L, 16R. For example, when a two-wheel drive running mode is selected by the electronic control device 100, the first clutch 24, the second clutch 32, the left control coupling 34L, and the right control coupling 34R are respectively released. This leads to formation of the two-wheel drive state in which the drive power is transmitted from the engine 12 via the front-wheel drive power distributing unit 20 to the left-side and right-side front wheels 14L, 14R. Therefore, the four-wheel drive vehicle 10 is a vehicle in which the two-wheel drive state and the four-wheel drive state are selectively switched by the electronic control device 100. Regarding the first clutch 24, the first clutch 24 is engaged when the first movable sleeve 42 is moved to the first meshing position, and the first clutch 24 is released when the first movable sleeve 42 is moved to the first non-meshing position. Regarding the second clutch 32, the second clutch 32 is engaged when the second movable sleeve 54 is moved to the second meshing position, and the second clutch 32 is released when the second movable sleeve 54 is moved to the second non-meshing position.

In the four-wheel drive vehicle 10, a gear ratio between the driven pinion 28a disposed on the propeller shaft 28 and the ring gear 40a disposed on the front wheel 14 side is differentiated from a gear ratio between the drive pinion 28b disposed on the propeller shaft 28 and the ring gear 50a disposed on the rear wheel 16 side, such that a rotation speed of the ring gear 50a becomes slightly faster than a rotation speed of the ring gear 40a. As a result, during running in the four-wheel drive state, the input-side friction member and the output-side friction member slip relatively in each of the left control coupling 34L and the right control coupling 34R.

Returning to FIG. 1, the four-wheel drive vehicle 10 includes a braking device 58 generating a braking force (braking torque) on the left-side front wheel 14L, the right-side front wheel 14R, the left-side rear wheel 16L, and the right-side rear wheel 16R. The braking device 58 corresponds to a brake of the present invention. The braking device 58 is a so-called disk brake well known as a service brake. As shown in FIG. 1, the braking device 58 includes disks 60 respectively fixed to the front wheel axles 22L, 22R and the rear wheel axles 36L, 36R, calipers 66 disposed on members constituting suspensions coupled to a vehicle body, etc., a brake actuator 68, etc. The disks 60 rotate together with respective wheels of the left-side front wheel 14L, the right-side front wheel 14R, the left-side rear wheel 16L, and the right-side rear wheel 16R. The calipers 66 clamp the disks 60 via brake pads (not shown) in accordance with brake hydraulic pressures Br (MPa) supplied from a master cylinder 64 etc, depending on an operation amount of a brake pedal 62, The brake actuator 68 includes, for example, a hydraulic pump or an accumulator generating a source pressure of the brake hydraulic pressures Br and a plurality of solenoid valves 70 regulating the brake hydraulic pressures Br of the calipers 66 disposed on the wheels and is a device supplying the brake hydraulic pressures Br to the calipers 66 of the wheels and regulating and controlling the supplied brake hydraulic pressures Br in accordance with a command signal Ss from the electronic control device 100.

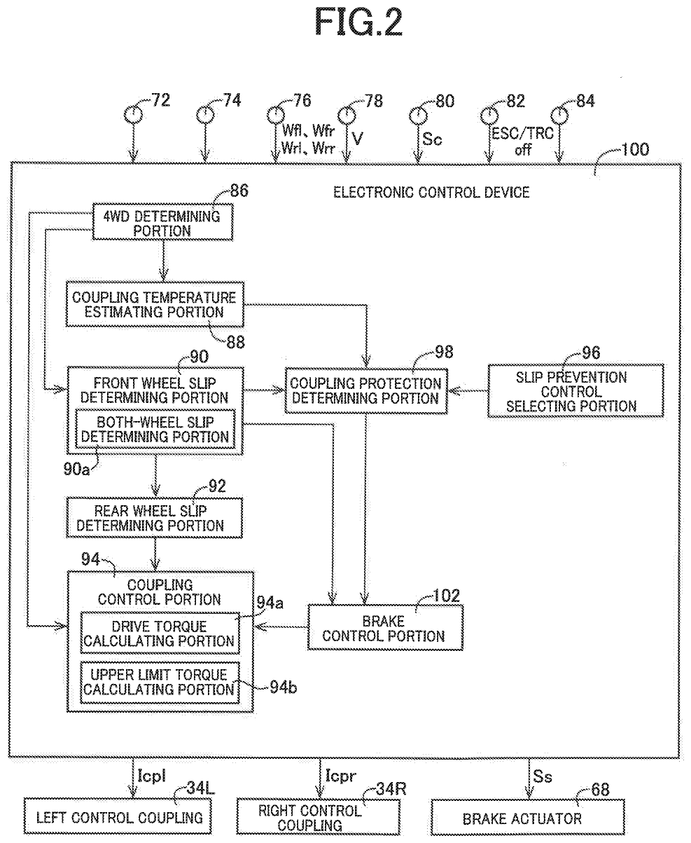

FIG. 2 is a functional block diagram for explaining main portions of a control function of the electronic control device 100 disposed on the four-wheel drive vehicle 10 of FIG. 1. The electronic control device 100 includes a so-called microcomputer including a CPU, a RAM, a ROM, and an I/O interface, for example, and the CPU executes signal processes in accordance with a program stored in advance in the ROM, while utilizing a temporary storage function of the RAM, to provide various controls of the four-wheel drive vehicle 10. As shown in FIG. 2, the electronic control device 100 is supplied with various input signals detected by sensors disposed on the four-wheel drive vehicle 10. For example, the signals input to the electronic control device 100 include: an ON/OFF signal indicative of whether the first clutch 24 is engaged, i.e., an ON/OFF signal indicative of whether the first movable sleeve 42 is at the first meshing position, detected by a first position sensor 72; an ON/OFF signal indicative of whether the second clutch 32 is engaged, i.e., an ON/OFF signal indicative of whether the second movable sleeve 54 is at the second meshing position, detected by a second position sensor 74; signals indicative of wheel speeds Wfl, Wfr, Wrl, Wrr (rpm) of the left-side front wheel 14L, the right-side front wheel 14R, the left-side rear wheel 16L, and the right-side rear wheel 16R detected by a wheel speed sensor 76; a signal indicative of the vehicle speed V (km/h) detected by a vehicle speed sensor 78; a signal indicative of a rotation speed Sc (rpm) of the central axle 48 detected by a rotation speed sensor 80; a signal ESC/TRCoff indicative of cancelation of both a sideslip prevention control (Electronic Stability Control; ESC) and a traction control (Traction Control; TRC) by the driver detected by an ESC/TRC cancelation switch 82; and a signal indicative of a selection of a paved road surface running mode for suitably running on a paved road surface of, for example, asphalt, other than off-road by the driver detected by a select switch 84.

Various output signals are supplied from the electronic control device 100 to devices disposed on the four-wheel drive vehicle 10. For example, the output signals include the left coupling drive current Icpl supplied to the electromagnetic coil of the actuator disposed in the left control coupling 34L, the right coupling drive current Icpr supplied to the electromagnetic coil of the actuator disposed in the right control coupling 34R, the first clutch drive current Ic1 (see FIG. 1) supplied to the first actuator 44 of the first clutch 24, the second clutch drive current Ic2 (see FIG. 1) supplied to the second actuator 56 of the second clutch 32, and the command signal Ss supplied to the solenoid

As shown in FIG. 2, the electronic control device 100 includes, for example, a 4WD determining portion 86, a coupling temperature estimating portion 88, a front wheel slip determining portion 90, a rear wheel slip determining portion 92, a coupling control portion 94, a slip prevention control selecting portion 96, a coupling protection determining portion 98, and a brake control portion 102.

The 4WD determining portion 86 determines whether the vehicle 10 is in the four-wheel drive state in which the drive power from the engine 12 is transmitted to the left-side and right-side front wheels 14L, 14R and the left-side and right-side rear wheels 16L, 16R. For example, when it is detected by the first position sensor 72 that the first movable sleeve 42 is at the first meshing position and it is detected by the second position sensor 74 that the second movable sleeve 54 is at the second meshing position, the 4WD determining portion 86 determines that the vehicle 10 is in the four-wheel drive state.

When the 4WD determining portion 86 determines that the vehicle 10 is in the four-wheel drive state, the coupling temperature estimating portion 88 estimates a temperature Tcl (° C.) of the left control coupling 34L, i.e., a temperature Tcl (° C.) of the input-side friction member and the output-side friction member disposed in the left control coupling 34L, and a temperature Tcr (° C.) of the right control coupling 34R, i.e., a temperature Tcr (° C.) of the input-side friction member and the output-side friction member disposed in the right control coupling 34R. The coupling temperature estimating portion 88 estimates an amount Ql of heat generation between the input-side friction member and the output-side friction member in the left control coupling 34L from a slip amount between the input-side friction member and the output-side friction member in the left control coupling 34L and the fastening power between the input-side friction member and the output-side friction member in the left control coupling 34L and estimates the temperature Tcl (° C.) of the left control coupling 34L from the estimated amount Ql of heat generation. The coupling temperature estimating portion 88 estimates an amount Qr of heat generation between the input-side friction member and the output-side friction member from a slip amount between the input-side friction member and the output-side friction member in the right control coupling 34R and the fastening power between the input-side friction member and the output-side friction member in the right control coupling 34R and estimates the temperature Tcr (° C.) of the right control coupling 34R from the estimated amount Qr of heat generation. The slip amount of the left control coupling 34L is obtained from the wheel speed Wrl (rpm) of the left-side rear wheel 16L detected by the wheel speed sensor 76 and the rotation speed Sc (rpm) of the central axle 48 detected by the rotation speed sensor 80. The slip amount of the right control coupling 34R is obtained from the wheel speed Wrr (rpm) of the right-side rear wheel 16R detected by the wheel speed sensor 76 and the rotation speed Sc (rpm) of the central axle 48 detected by the rotation speed sensor 80.

When the 4WD determining portion 86 determines that the vehicle 10 is in the four-wheel drive state, the front wheel slip determining portion 90 determines whether a slip is occurring on at least one of the left-side and right-side front wheels 14L, 14R For example, if a difference between the wheel speed Wfl (rpm) of the left-side front wheel 14L and the wheel speed Wfr (rpm) of the right-side front wheel 14R detected by the wheel speed sensor 76 is larger than a preset slip determination value Dsf (rpm), the front wheel slip determining portion 90 determines that a slip is occurring on at least one of the left-side and right-side front wheels 14L, 14R.

When the front wheel slip determining portion 90 determines that a slip is occurring on at least one of the left-side and right-side front wheels 14L, 14R, the rear wheel slip determining portion 92 determines whether a slip is occurring on at least one of the left-side and right-side rear wheels 16L, 16R For example, if a difference between the wheel speed Wrl (rpm) of the left-side rear wheel 16L and the wheel speed Wrr (rpm) of the right-side rear wheel 16R detected by the wheel speed sensor 76 is larger than a preset slip determination value Dsr (rpm), the rear wheel slip determining portion 92 determines that a slip is occurring on at least one of the left-side and right-side rear wheels 16L, 16R.

The front wheel slip determining portion 90 includes a both-wheel slip determining portion 90a. When the front wheel slip determining portion 90 determines that a slip is occurring on at least one of the left-side and right-side front wheels 14L, 14R, the both-wheel slip determining portion 90a determines whether both wheels of the left-side and right-side front wheels 14L, 14R are slipping. For example, if the wheel speeds Wfl, Wfr (rpm) of the left-side and right-side front wheels 14L, 14R are each faster than a slower one between the wheel speed Wrl (rpm) of the left-side rear wheel 16L and the wheel speed Wrr (rpm) of the right-side rear wheel 16R, the both-wheel slip determining portion 90a determines that both wheels of the left-side and right-side front wheels 14L, 14R are slipping.

When the 4WD determining portion 86 determines that the vehicle 10 is in the four-wheel drive state, the coupling control portion 94 controls the fastening power between the input-side friction member and the output-side friction member disposed in each of the left and right control couplings 34L, 34R. Specifically, the coupling control portion 94 controls the transmission torque transmitted between the left-side rear wheel 16L and the central axle 48 in the left control coupling 34L, and the transmission torque transmitted between the right-side rear wheel 16R and the central axle 48 in the right control coupling 34R. The coupling control portion 94 controls the transmission torques of the left and right control couplings 34L, 34R such that a torque distribution ratio between a front wheel drive torque transmitted to the front wheels 14 and a rear wheel drive torque transmitted to the rear wheels 16 becomes equal to a target front/rear wheel shared load ratio estimated from an acceleration in the longitudinal direction of the vehicle 10 detected from a longitudinal acceleration sensor and a road surface grade detected from a road surface grade sensor, for example. The four-wheel drive vehicle 10 of this example can control the transmission torques of the left control coupling 34L and the right control coupling 34R during four-wheel drive running to continuously vary the torque distribution ratio between the front wheel drive torque and the rear wheel drive torque between 100:0 and 50:50.

When the 4WD determining portion 86 determines that the vehicle 10 is in the four-wheel drive state and the front wheel slip determining portion 90 determines that a slip is occurring on at least one of the left-side and right-side front wheels 14L, 14R, the coupling control portion 94 provides a drive torque distribution control of increasing the transmission torques of the left and right control couplings 34L, 34R so as to increase the rear wheel drive torque transmitted to the rear wheels 16.

The slip prevention control selecting portion 96 selects between the provision of a slip prevention control and the stop of the slip prevention control. For example, if the driver operates the ESC/TRC cancelation switch 82 to cancel both the sideslip prevention control and the traction, control and the driver operates the select switch 84 to select the paved road surface running mode, the slip prevention control selecting portion 96 selects the stop of the slip prevention control. Alternatively, if the driver does not operate the ESC/TRC cancelation switch 82 or the driver operates the select switch 84 to select, for example, an off-road road surface running mode rather than selecting the paved road surface running mode, the slip prevention control selecting portion 96 selects the provision of the slip prevention control. The slip prevention control is a control of automatically operating a brake to at least one of the left-side and right-side front wheels 14L, 14R when the at least one wheel slips during running of the vehicle 10.

When the slip prevention control selecting portion 96 selects the stop of the slip prevention control, the front wheel slip determining portion 90 determines that a slip is occurring on at least one of the left-side and right-side front wheels 14L, 14R, and it is determined that a slower wheel speed between the wheel speed Wrl of the left-side rear wheel 16L and the wheel speed Wrr of the right-side rear wheel 16R is lower than a stop determination speed Wc and thus the vehicle 10 is in a stop state, the coupling protection determining portion 98 determines whether the input-side friction member and the output-side friction member are overheated by a heat generated due to friction between the input-side friction member and the output-side friction member in at least one of the left control coupling 34L and the right control coupling 34R so that the control coupling needs to be protected. For example, when the temperature Tcl, Tcr (° C.) of at least one of the left control coupling 34L and the right control coupling 34R estimated by the coupling temperature estimating portion 88 is higher than a predetermined temperature Tc (° C.), the coupling protection determining portion 98 determines that the control coupling needs to be protected. The predetermined temperature Tc corresponds to the temperature Tcl, Tcr at which the input-side friction member and the output-side friction member disposed on the left control coupling 34L and the right control coupling 34R are highly possibly reduced in durability.

When the both-wheel slip determining portion 90a determines that both wheels of the left-side and right-side front wheels 14L, 14R are slipping and the coupling protection determining portion 98 determines that at least one of the control couplings 34L, 34R needs to be protected from the above-described heat, the brake control portion 102 operates the brake on both wheels of the left-side and right-side front wheels 14L, 14R. For example, the brake control portion 102 increases the brake hydraulic pressure Br (MPa) of the caliper 66 disposed on the left-side front wheel 14L so that a friction coefficient (μ) between the left-side front wheel 14L and the road surface becomes higher, and increases the brake hydraulic pressure Br (MPa) of the caliper 66 disposed on the right-side front wheel 14R so that a friction coefficient (μ) between the right-side front wheel 14R and the road surface becomes higher.

Alternatively, when the both-wheel slip determining portion 90a determines that both wheels of the left-side and right-side front wheels 14L, 14R are not slipping, i.e., the both-wheel slip determining portion 90a determines that one of the left-side and right-side front wheels 14L, 14R is slipping, and the coupling protection determining portion 98 determines that at least one of the control couplings 34L, 34R needs to be protected, the brake control portion 102 operates the brake on a slipping front wheel 14 of the front wheels 14. For example, the brake control portion 102 increases the brake hydraulic pressure Br so that the friction coefficient (μ) becomes higher between the left-side front wheel 14L/the right-side front wheel 14R and the road surface, i.e., so that a differential rotation speed (slip amount) between the slipping front wheel 14 and the non-slipping front wheel 14 falls within a predetermined range. When the both-wheel slip determining portion 90a determines that one of the left-side and right-side front wheels 14L, 14R is slipping, the slipping front wheel 14 described above is a front wheel 14 having larger speed between the wheel speeds Wfl, Wfr. When the both-wheel slip determining portion 90a determines that one of the left-side and right-side front wheels 141L, 14R is slipping, the non-slipping front wheel 14 described above is a front wheel 14 having smaller speed between the wheel speeds Wfl, Wfr.

The coupling control portion 94 includes a drive torque calculating portion 94a and an upper limit torque calculating portion 94b. When the both-wheel slip determining portion 90a determines that one of the left-side and right-side front wheels 14L, 14R is slipping and the brake control portion 102 operates a brake on the slipping front wheel 14 of the front wheels 14 and determines that the brake is actuated, the drive torque calculating portion 94a calculates a drive torque Te (Nm) generated by the brake. For example, the drive torque calculating portion 94a calculates a braking torque Tbr (Nm) acting on the slipping front wheel 14 of the front wheels 14 and calculates the drive torque Te as a torque having the same magnitude as the calculated braking torque Tbr and a direction opposite to that of the braking torque Tbr. For example, if the braking torque Tbr is −50 (Nm), the drive torque Te is 50 (Nm). The braking torque Tbr (Nm) is calculated by using, for example, a map showing a relationship obtained in advance from the brake hydraulic pressure Br (MN) supplied to the caliper 66 disposed on the slipping front wheel 14 of the front wheels 14 in the brake control portion 102.

When the drive torque calculating portion 94a calculates the drive torque Te (Nm) generated by the brake and the rear wheel slip determining portion 92 determines that a slip is occurring on the one rear wheel 16 of the left-side and right-side rear wheels 16L, 16R, the upper limit torque calculating portion 94b calculates an upper limit torque Tdmax (Nm) of the transmission torque transmitted from the central axle 48 to the non-slipping rear wheel 16 via the control coupling of the left and right control couplings 34L, 34R disposed on the non-slipping rear wheel 16. For example, the upper limit torque calculating portion 94b calculates a half amount of the drive torque Te calculated by the drive torque calculating portion 94a as the upper limit torque Tdmax (Te/2). When the rear wheel slip determining portion 92 determines that a slip is occurring on the one rear wheel 16 of the left-side and right-side rear wheels 16L, 16R, the slipping rear wheel 16 described above is a rear wheel 16 having larger speed between the wheel speeds Wrl, Wrr. When the rear wheel slip determining portion 92 determines that a slip is occurring on the one rear wheel 16 of the left-side and right-side rear wheels 16L, 16R, the non-slipping rear wheel 16 described above is a rear wheel 16 having smaller speed between the wheel speeds Wrl, Wrr.

When the drive torque calculating portion 94a calculates the drive torque Te (Nm) generated by the brake and the rear wheel slip determining portion 92 determines that a slip is occurring on none of the left-side and right-side rear wheels 16L, 16R, the upper limit torque calculating portion 94b calculates a left-side upper limit torque Tdlmax (Nm) of the transmission torque transmitted from the center axle 48 to the left-side rear wheel 16L via the left control coupling 34L and a right-side upper limit torque Tdrmax (Nm) of the transmission torque transmitted from the center axle 48 to the right-side rear wheel 16R via the right control coupling 34R. For example, the upper limit torque calculating portion 94b calculates ¼ of the drive torque Te calculated by the drive torque calculating portion 94a as the left-side upper limit torque Tdlmax (Te/4) and calculates ¼ of the drive torque Te calculated by the drive torque calculating portion 94a as the right-side upper limit torque Tdrmax (Te/4).

When the drive torque calculating portion 94a calculates the drive torque Te (Nm) generated by the brake and the upper limit torque calculating portion 94b calculates the upper limit torque Tdmax (Nm) of the transmission torque, the coupling control portion 94 increases the transmission torque of the control coupling of the left and right control couplings 34L, 34R disposed on the non-slipping rear wheel 16 depending on the intensity of the brake operated to the slipping front wheel 14 by the brake control portion 102. For example, the coupling control portion 94 increases the transmission torque of the control coupling of the left and right control couplings 34L, 34R disposed on the non-slipping rear wheel 16 to the upper limit torque Tdmax depending on the magnitude of the braking torque Tbr (NM) acting on the slipping front wheel 14, i.e., the magnitude of the drive torque Te (Nm) generated in the vehicle 10. When the drive torque calculating portion 94a calculates the drive torque Te (Nm) generated by the brake and the upper limit torque calculating portion 94b calculates the upper limit torque Tdmax (Nm) of the transmission torque, the coupling control portion 94 sets the transmission torque of the control coupling of the left and right control couplings 34L, 34R disposed on the slipping rear wheel 16 to zero (Nm).

When the drive torque calculating portion 94a calculates the drive torque Te (Nm) generated by the brake and the upper limit torque calculating portion 94b calculates the left-side upper limit torque Tdlmax (Nm) and the right-side upper limit torque Tdrmax (Nm), the coupling control portion 94 increases the transmission torques of the left and right control couplings 34L, 34R depending on the intensity of the brake operated to the slipping front wheel 14 by the brake control portion 102. For example, the coupling control portion 94 increases the transmission torque of the left control coupling 34L to the left-side upper limit torque Tdlmax and the transmission torque of the right control coupling 34R to the right-side upper limit torque Tdrmax depending on the magnitude of the braking torque Tbr (Nm) acting on the slipping front wheel 14, i.e., the magnitude of the drive torque Te (Nm) generated in the vehicle 10.

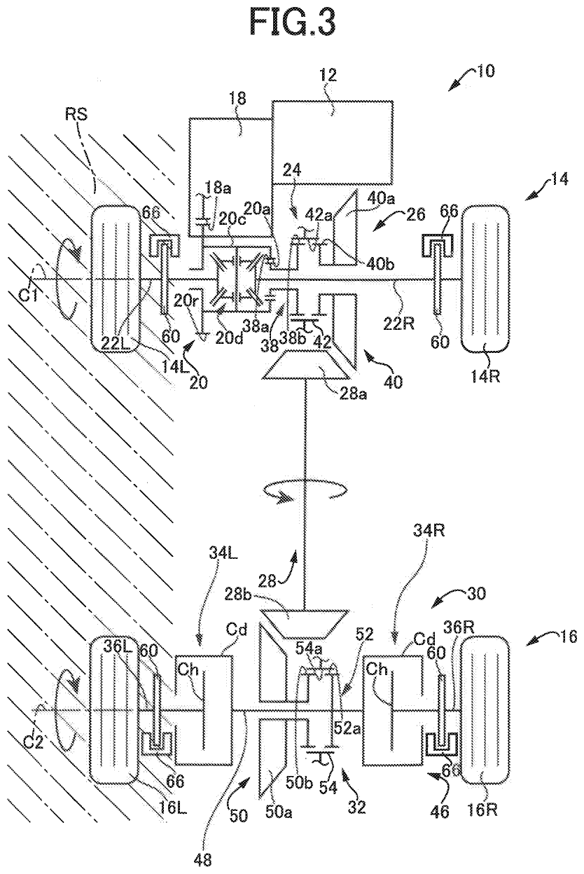

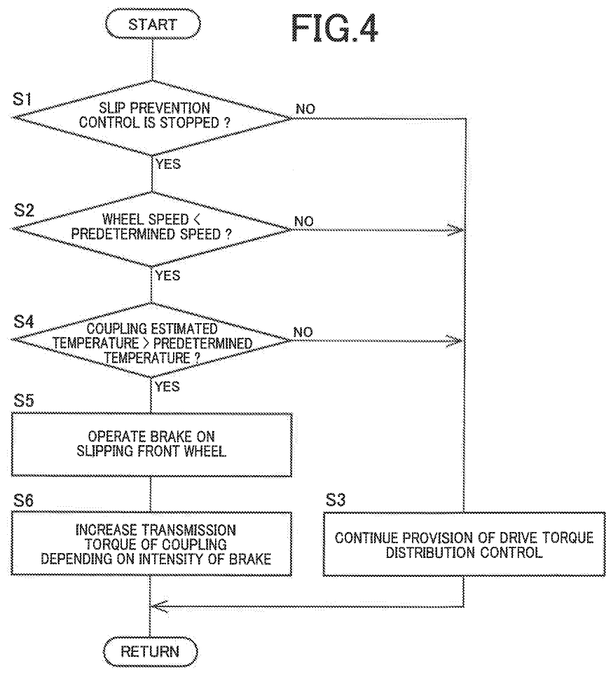

FIG. 4 is a flowchart for explaining an example of control operation in the electronic control device 100 for the braking device 58 and the left and right control couplings 34L, 34R when the vehicle 10 starts in the four-wheel drive state on a road where friction coefficients (μ) are different between the left and right side of the vehicle 10 as shown in FIG. 3, and both the left-side front wheel 14L and the left-side rear wheel 16L on a road surface RS having relative low friction coefficient μ side are slipping. At the start of the flowchart of FIG. 4, the left-side front wheel 14L is slipping, and therefore, the coupling control portion 94 is providing the drive torque distribution control of increasing the transmission torques of the left and right control couplings 34L, 34R so as to increase the rear wheel drive torque transmitted to the rear wheels 16.

First, at step (hereinafter, step is omitted) S1 corresponding to the function of the slip prevention control selecting portion 96, it is determined whether the stop of the slip prevention control is selected, i.e., whether the slip prevention control is stopped. If the determination of S2 is affirmative, i.e., if the stop of the slip prevention control is selected, S2 corresponding to the function of the coupling protection determining portion 98 is executed, and if the determination of S1 is negative, i.e., if the provision of the slip prevention control is selected, S3 corresponding to the function of the coupling control portion 94 is executed. At S2, it is determined whether the wheel speed of the non-slipping wheel of the rear wheels 16, e.g. the wheel speed Wrr of the right-side rear wheel 16R, which is relatively slow wheel speed of the wheel speed Wrl of the left-side rear wheel 16L and the wheel speed Wrr of the right-side rear wheel 16R, is slower than the stop determination speed Wc for determining a predetermined stop state. If the determination of S2 is affirmative, S4 corresponding to the functions of the coupling temperature estimating portion 88 and the coupling protection determining portion 98 is executed, and if the determination of S2 is negative, S3 is executed. At S3, the provision of the drive torque distribution control is continued.

At S4, it is determined whether at least one control coupling temperature of the temperature Tcl (° C.) of the left control coupling 34L and the temperature Tcr (CC) of the right control coupling 34R estimated by the coupling temperature estimating portion 88, for example, the temperature Tcr (° C.) of the right control coupling 34R, is higher than the predetermined temperature Tc (° C.). If the determination of S4 is affirmative, S5 corresponding to the function of the brake control portion 102 is executed, and if the determination of S4 is negative, S3 is executed. At S5, the brake is operated to the left-side front wheel 14L, i.e., the slipping front wheel 14. Subsequently, at S6 corresponding to the functions of the drive torque calculating portion 94a, the upper limit torque calculating portion 94b, and the coupling control portion 94, the transmission torque of the right control coupling 34R is increased to the upper limit torque Tdrmax depending on the magnitude of the braking torque Tbr (Nm) acting on the left-side front wheel 14L.

As described above, according to the electronic control device 100 of the four-wheel drive vehicle 10 of this example, when the stop of the slip prevention control is selected, and it is detected that at least one of the left-side and right-side front wheels 14L, 14R has slipped in the four-wheel drive state, the brake is operated to the slipping front wheel 14 to make the rotation speed Sc of the central axle 48 lower than the rotation speed Sc of the central axle 48 at the time of detection of the slip of the front wheel 14. By making the rotation speed Sc of the central axle 48 lower than the rotation speed Sc of the central axle 48 at the time of detection of the slip of the front wheel 14, the rotation speeds of the input-side friction members are reduced in the left control coupling 34L and the right control coupling 34R, and respective differential rotation speeds become smaller between the input-side friction members and the output-side friction members in the left control coupling 34L and the right control coupling 34R, so that the left control coupling 34L and the right control coupling 34R can be prevented from overheating. Additionally, for example, when one of the front wheels 14 of the left-side and right-side front wheels 14L, 14R slips and the brake is operated to the slipping front wheel 14, the slipping front wheel 14 is braked, and the drive power is transmitted to the non-slipping front wheel 14 by the front-wheel drive power distributing unit 20 acting as a differential device, so that the drive power for starting the vehicle 10 can suitably be ensured.

According to the electronic control device 100 of the four-wheel drive vehicle 10 of this example, when the stop of the slip prevention control is selected, and it is detected that one of the front wheels 14 of the left-side and right-side front wheels 14L, 14R has slipped in the four-wheel drive state, the brake is operated to the slipping front wheel 14 of the front wheels 14L, 14R to increase the fastening powers of the left control coupling 34L and the right control coupling 34R respectively depending on the intensity of the brake. Therefore, the drive power is transmitted from the engine 12 to the non-slipping front wheel 14 so that the drive power transmitted to the rear wheels 16 is reduced, while the fastening powers of the left control coupling 34L and the right control coupling 34R respectively are no longer increased regardless of the intensity of the brake, so that the left control coupling 34L and the right control coupling 34R can suitably be prevented from being overheated.

Subsequently, other examples of the present invention will be described in detail with reference to the drawings. In the following description, the portions common to the examples are denoted by the same reference numerals and will not be described.

### SECOND EXAMPLE

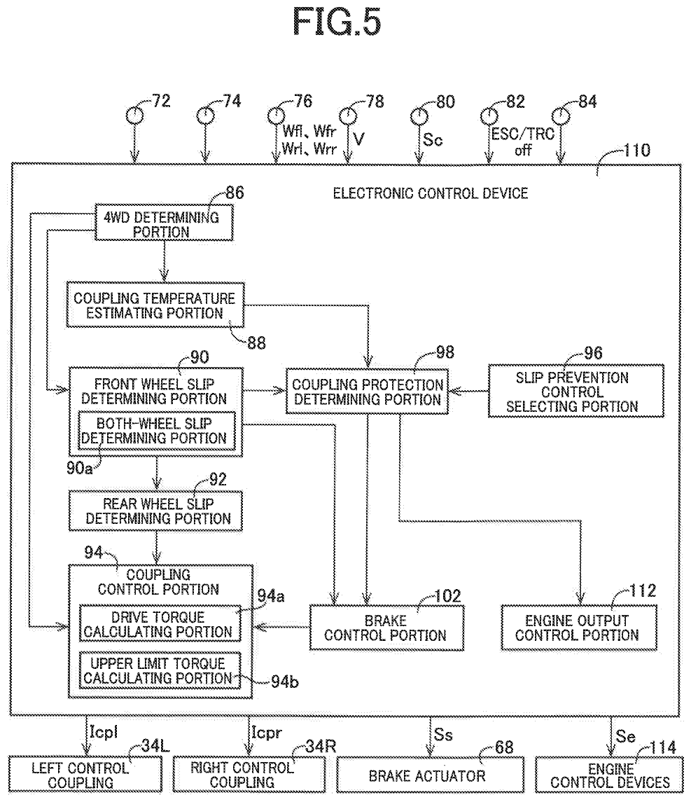

An electronic control device (control device) 110 of the four-wheel drive vehicle 10 of this example is substantially the same as the electronic control device 100 of the four-wheel drive vehicle 10 of the first example except that an engine output control portion 112 is added as shown in FIG. 5. From the electronic control device 110, an engine output control command signal Se for controlling the engine 12 is supplied to an engine control device 114 including a throttle actuator, a fuel injection device, and an ignition device, for example.

The engine output control portion 112 outputs the engine output control command signals Se respectively to the throttle actuator, the fuel injection device, and the ignition device for output control of the engine 12, for example. For example, the engine output control portion 112 calculates a required drive output. Pdem as a drive request amount from the driver based on actual accelerator opening degree θacc and vehicle speed V from a predefined relationship (drive power map) not shown, sets a target engine torque Tetgt for acquiring the required drive output Pdem, and provides control for obtaining the target engine torque Tetgt such as opening and closing an electronic throttle valve with the throttle actuator, controlling a fuel injection amount with the fuel injection device, and an ignition timing with the ignition device.

When the coupling protection determining portion 98 determines that at least one of the control couplings 34L, 34R needs to be protected, i.e., when the slip prevention control selecting portion 96 selects the stop of the slip prevention control and the front wheel slip determining portion 90 determines that a slip is occurring on at least one of the left-side and right-side front wheels 14L, 14R while it is determined that the temperature Tcl, Tcr (° C.) of at least one of the left control coupling 34L and the right control coupling 34R estimated by the coupling temperature estimating portion 88 is higher than the predetermined temperature Tc (° C.), the engine output control portion 112 calculates the required drive output Pdem to be lower than that when the coupling protection determining portion 98 determines that at least one of the control couplings 34L, 34R does not need to be protected, sets the target engine torque Tetgt for acquiring the required drive output Pdem, and provides control for obtaining the target engine torque Tetgt, such as opening and closing the electronic throttle valve with the throttle actuator, controlling the fuel injection amount with the fuel injection device, and the ignition timing with the ignition device. Therefore, when the stop of the slip prevention control is selected, and it is detected that at least one of the left-side and right-side front wheels 14L, 14R has slipped in the four-wheel drive state, the engine output control portion 112 reduces the drive power of the engine 12 as compared to the drive power output from the engine 12 at the time of detection of the slip of the front wheel 14.

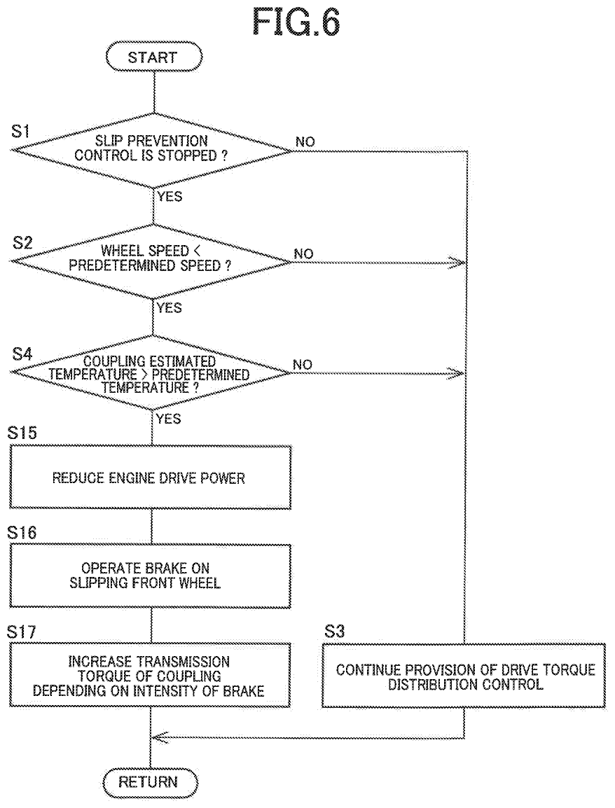

FIG. 6 is a flowchart for explaining an example of control operation in the electronic control device 110 for the braking device 58, the left and right control couplings 34L, 34R, and the engine 12 when the vehicle 10 starts in the four-wheel drive state on a road where friction coefficients (μ) are different between the left and right sides of the vehicle 10 as shown in FIG. 3, and both the left-side front wheel 14L and the left-side rear wheel 16L on the road surface RS having relative low friction coefficient μ side are slipping. At the start of the flowchart of FIG. 6, as with the start of the flowchart of FIG. 4, the left-side front wheel 14L is slipping, and therefore, the coupling control portion 94 is providing the drive torque distribution control of increasing the transmission torques of the left and right control couplings 34L, 34R so as to increase the rear wheel drive torque transmitted to the rear wheels 16. Since S1 to S4 of FIG. 6 have the same contents as S1 to S4 of FIG. 4, S1 to S4 of the flowchart of FIG. 6 will not be described.

If the determination of S4 is affirmative, S15 corresponding to the function of the engine output control portion 112 is executed, and if the determination of 54 is negative, S3 is executed. At S15, the drive power of the engine 12 is reduced as compared to the drive power output from engine 12 at the time of detection of the slip of the front wheel 14. Subsequently, at S16 corresponding to the function of the brake control portion 102, the brake is operated to the left-side front wheel 14L, i.e., the slipping front wheel 14. Subsequently, at S17 corresponding to the functions of the drive torque calculating portion 94a, the upper limit torque calculating portion 94b, and the coupling control portion 94, the transmission torque of the right control coupling 34R is increased to the upper limit torque Tdrmax depending on the magnitude of the braking torque Tbr (Nm) acting on the left-side front wheel 14L.

As described above, according to the electronic control device 110 of the four-wheel drive vehicle 10 of this example, when the stop of the slip prevention control is selected, and it is detected that at least one of the front wheels 14 of the left-side and right-side front wheels 14L, 14R has slipped in the four-wheel drive state, the drive power of the engine 12 is reduced as compared to the drive power output from engine 12 at the time of detection of the slip of the front wheel 14, and the rotation speed Sc of the central axle 48 is made lower than the rotation speed Sc of the central axle 48 at the time of detection of the slip of the front wheel 14. By making the rotation speed Sc of the central axle 48 lower than the rotation speed Sc of the central axle 48 at the time of detection of the slip of the front wheel 14, the rotation speeds of the input-side friction members are reduced in the left control coupling 34L and the right control coupling 34R, and respective differential rotation speeds become smaller between the input-side friction members and the output-side friction members in the left control coupling 34L and the right control coupling 34R, so that the left control coupling 34L and the right control coupling 34R can be prevented from overheating.

### THIRD EXAMPLE

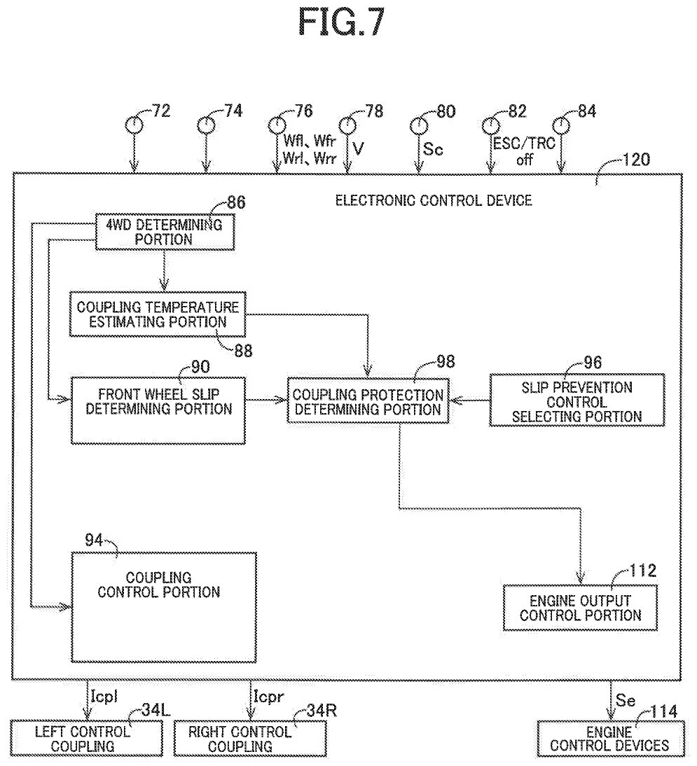

An electronic control device (control device) 120 of the four-wheel drive vehicle 10 of this example is substantially the same as the electronic control device 110 of the four-wheel drive vehicle 10 of the second example except that the brake control portion 102 and the rear wheel slip determining portion 92 are eliminated, that the both-wheel slip determining portion 90a included in the front wheel slip determining portion 90 is eliminated, and that the drive torque calculating portion 94a and the upper limit torque calculating portion 94b included in the coupling control portion 94 are eliminated, as shown in FIG. 7. Therefore, in the electronic control device 120 of the four-wheel drive vehicle 10 of this example, even when the stop of the slip prevention control is selected, and it is detected that at least one of the left-side and right-side front wheels 14L, 14R has slipped in the four-wheel drive state, the brake cannot be operated to the slipping front wheel 14 of the left-side and right-side front wheels 141, 14R.

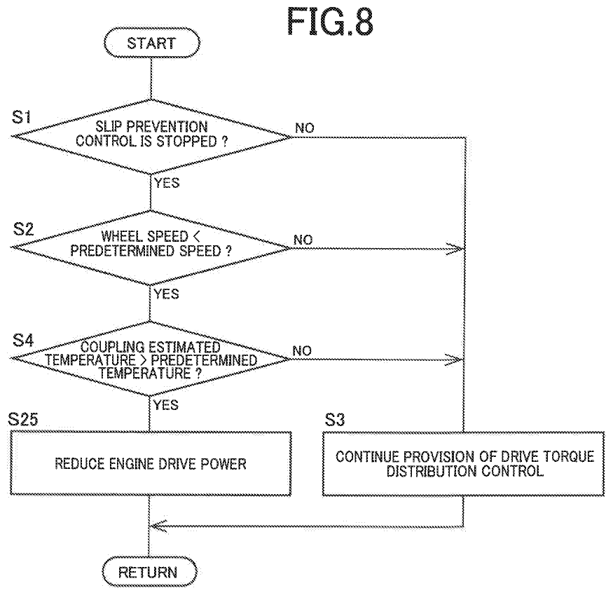

FIG. 8 is a flowchart for explaining an example of control operation in the electronic control device 120 for the left and right control couplings 34L, 34R, and the engine 12 when the vehicle 10 starts in the four-wheel drive state on a road where friction coefficients (μ) are different between the left and right sides of the vehicle 10 as shown in FIG. 3, and both the left-side front wheel 14L and the left-side rear wheel 16L on the road surface RS having relative low friction coefficient μ side are slipping. At the start of the flowchart of FIG. 8, as with the start of the flowchart of FIG. 4, the left-side front wheel 14L is slipping, and therefore, the coupling control portion 94 is providing the drive torque distribution control of increasing the transmission torques of the left and right control couplings 34L, 34R so as to increase the rear wheel drive torque transmitted to the rear wheels 16. Since S1 to S4 of FIG. 8 have the same contents as S1 to S4 of FIG. 4, S1 to S4 of the flowchart of FIG. 8 will not be described.

If the determination of S4 is affirmative, S25 corresponding to the function of the engine output control portion 112 is executed, and if the determination of S4 is negative, S3 is executed. At S25, the drive power of the engine 12 is reduced as compared to the drive power output from engine 12 at the time of detection of the slip of the front wheel 14.

### FOURTH EXAMPLE

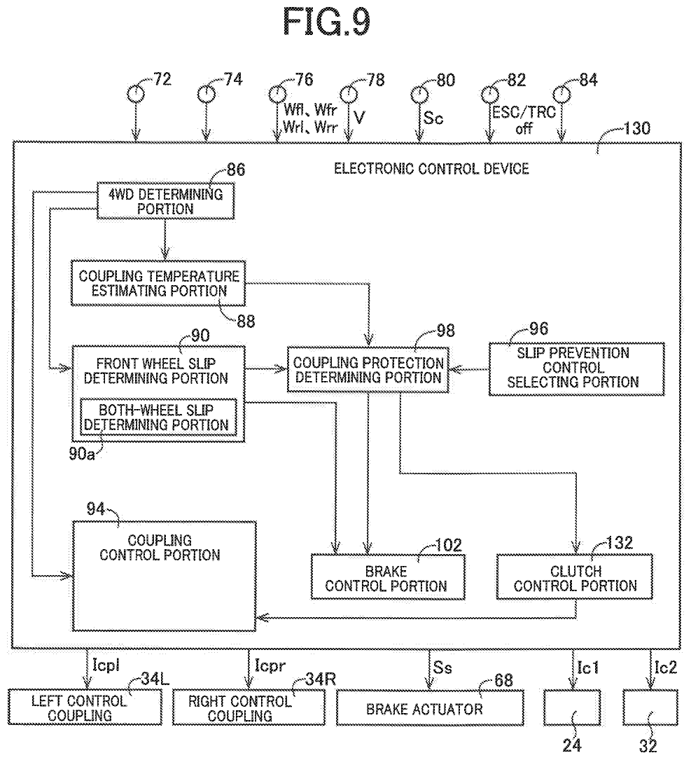

An electronic control device (control device) 130 of the four-wheel drive vehicle 10 of this example is substantially the same as the electronic control device 100 of the four-wheel drive vehicle 10 of the first example except that a clutch control portion 132 is added, that the rear wheel slip determining portion 92 is eliminated, and that the drive torque calculating portion 94a and the upper limit torque calculating portion 94b included in the coupling control portion 94 are eliminated, as shown in FIG. 9.

The clutch control portion 132 controls the first clutch drive current Ic1 supplied to the first actuator 44 of the first clutch 24 and the second clutch drive current Ic2 supplied to the second actuator 56 of the second clutch 32 to control engagement or release of the first clutch 24 and the second clutch 32. For example, when the four-wheel drive running mode is selected by the electronic control device 130, the clutch control portion 132 controls the first clutch drive current Ic1 and the second clutch drive current Ic2 such that the first clutch 24 and the second clutch 32 are each engaged. For example, when the two-wheel drive running mode is selected by the electronic control device 130, the clutch control portion 132 controls the first clutch drive current Ic1 and the second clutch drive current Ic2 such that the first clutch 24 and the second clutch 32 are each released.

When the coupling protection determining portion 98 determines that at least one of the control couplings 34L, 34R needs to be protected, i.e., when the slip prevention control selecting portion 96 selects the stop of the slip prevention control and the front wheel slip determining portion 90 determines that a slip is occurring on at least one of the left-side and right-side front wheels 14L, 14R while it is determined that the temperature Tcl, Tcr (° C.) of at least one of the left control coupling 34L and the right control coupling 34R estimated by the coupling temperature estimating portion 88 is higher than the predetermined temperature Tc (° C.), the clutch control portion 132 controls the first clutch drive current Ic1 and the second clutch drive current Ic2 such that the first clutch 24 and the second clutch 32 are each released. Therefore, when the stop of the slip prevention control is selected, and it is detected that at least one of the left-side and right-side front wheels 14L, 14R has slipped in the four-wheel drive state, the clutch control portion 132 releases each of the first clutch 24 and the second clutch 32.

When the first clutch 24 and the second clutch 32 are each released by the clutch control portion 132, the coupling control portion 94 sets the transmission torques of the left and right control couplings 34L, 34R to zero (Nm).

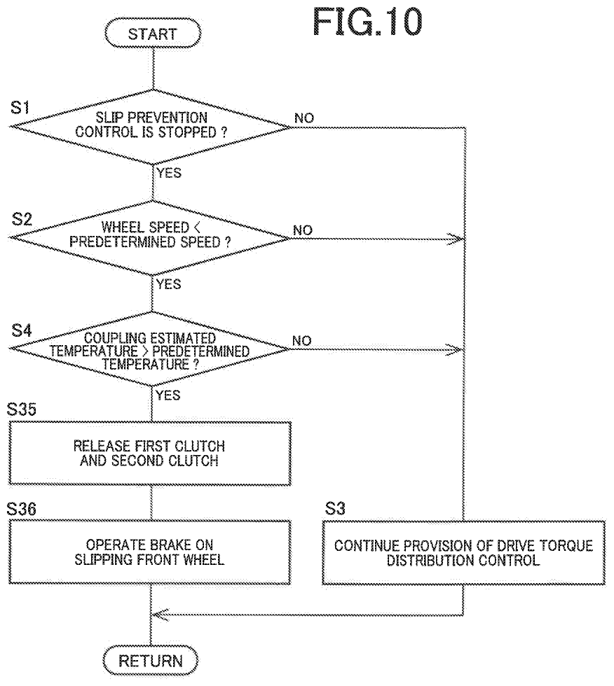

FIG. 10 is a flowchart for explaining an example of control operation in the electronic control device 130 for the braking device 58, the left and right control couplings 34L, 34R, and the first and second clutches 24, 32 when the vehicle 10 starts in the four-wheel drive state on a road where friction coefficients (μ) are different between the left and right sides of the vehicle 10 as shown in FIG. 3, and both the left-side front wheel 14L and the left-side rear wheel 16L on a road surface RS having relative low friction coefficient μ side are slipping. At the start of the flowchart of FIG. 10, as with the start of the flowchart of FIG. 4, the left-side front wheel 14L is slipping, and therefore, the coupling control portion 94 is providing the drive torque distribution control of increasing the transmission torques of the left and right control couplings 34L, 34R so as to increase the rear wheel drive torque transmitted to the rear wheels 16. Since S1 to 54 of FIG. 10 have the same contents as S1 to S4 of FIG. 4, S1 to S4 of the flowchart of FIG. 10 will not be described.

If the determination of S4 is affirmative, S35 corresponding to the function of the clutch control portion 132 is executed, and if the determination of S4 is negative, S3 is executed. At S35, the first clutch 24 and the second clutch 32 are each released. Subsequently, at S36 corresponding to the function of the brake control portion 102, the brake is operated to the left-side front wheel 14L, i.e., the slipping front wheel 14.

As described above, according to the electronic control device 130 of the four-wheel drive vehicle 10 of this example, when the stop of the slip prevention control is selected, and it is detected that at least one of the front wheels 14 of the left-side and right-side front wheels 14L, 14R has slipped in the four-wheel drive state, the first clutch 24 and the second clutch 32 are each released to make the rotation speed Sc of the central axle 48 lower than the rotation speed Sc of the central axle 48 at the time of detection of the slip of the front wheel 14. By making the rotation speed Sc of the central axle 48 lower than the rotation speed Sc of the central axle 48 at the time of detection of the slip of the front wheel 14, the rotation speeds of the input-side friction members are reduced in the left control coupling 34L and the right control coupling 34R, and respective differential rotation speeds become smaller between the input-side friction members and the output-side friction members in the left control coupling 34L and the right control coupling 34R, so that the left control coupling 34L and the right control coupling 34R can be prevented from overheating.

### FIFTH EXAMPLE

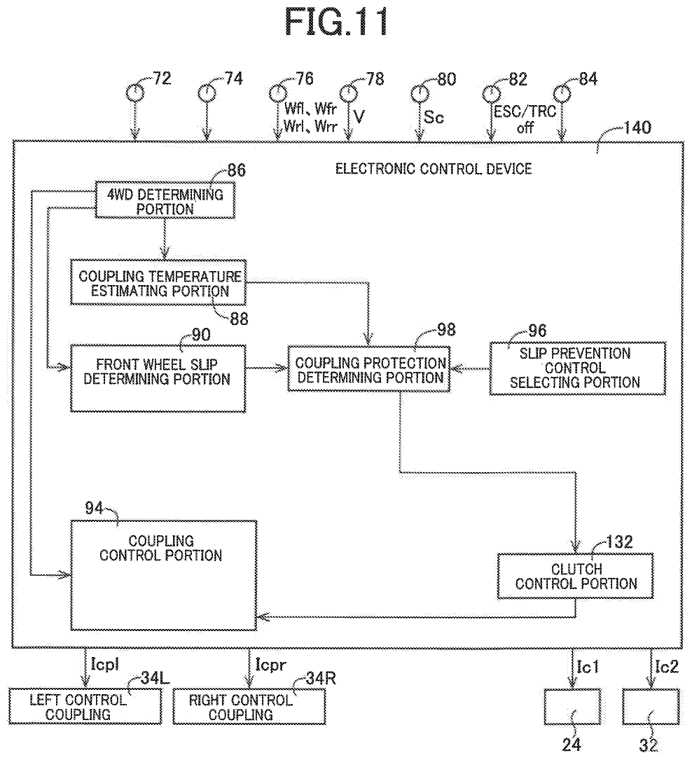

An electronic control device (control device) 140 of the four-wheel drive vehicle 10 of this example is substantially the same as the electronic control device 130 of the four-wheel drive vehicle 10 of the fourth example except that the brake control portion 102 is eliminated and that the both-wheel slip determining portion 90a included in the front wheel slip determining portion 90 is eliminated as shown in FIG. 11. Therefore, in the electronic control device 140 of the four-wheel drive vehicle 10 of this example, even when the stop of the slip prevention control is selected, and it is detected that at least one of the left-side and right-side front wheels 14L, 14R has slipped in the four-wheel drive state, the brake cannot be operated to the slipping front wheel 14 of the left-side and right-side front wheels 14L, 14R.

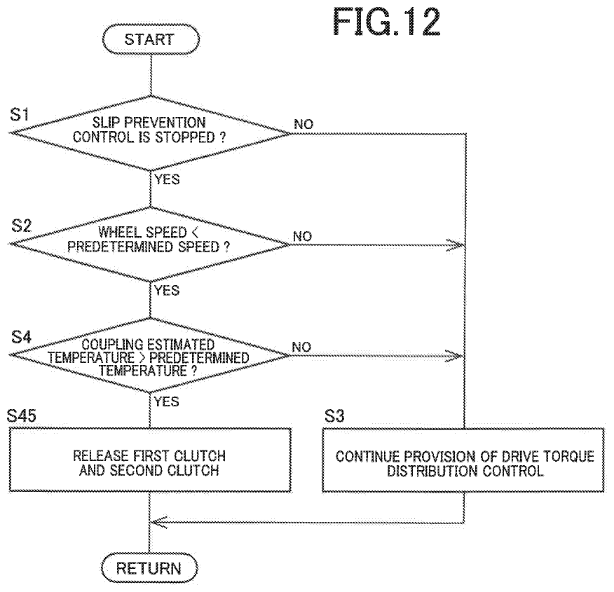

FIG. 12 is a flowchart for explaining an example of control operation in the electronic control device 140 for the left and right control couplings 34L, 34R and the first and second clutches 24, 32 when the vehicle 10 starts in the four-wheel drive state on a road where friction coefficients (μ) are different between the left and right sides of the vehicle 10 as shown in FIG. 3, and both the left-side front wheel 14L and the left-side rear wheel 16L on the road surface RS having relative low friction coefficient μ side are slipping. At the start of the flowchart of FIG. 12, as with the start of the flowchart of FIG. 4, the left-side front wheel 14L is slipping, and therefore, the coupling control portion 94 is providing the drive torque distribution control of increasing the transmission torques of the left and right control couplings 34L, 34R so as to increase the rear wheel drive torque transmitted to the rear wheels 16. Since S1 to S4 of FIG. 12 have the same contents as S1 to S4 of FIG. 4, S1 to S4 of the flowchart of FIG. 12 will not be described.

If the determination of S4 is affirmative, S45 corresponding to the function of the clutch control portion 132 is executed, and if the determination of 54 is negative, S3 is executed. At S45, the first clutch 24 and the second clutch 32 are each released.

### SIXTH EXAMPLE

An electronic control device (control device) 150 of the four-wheel drive vehicle 10 of this example is substantially the same as the electronic control device 100 of the four-wheel drive vehicle 10 of the first example except that a shift control portion 152 is added, that the rear wheel slip determining portion 92 and the brake control portion 102 are eliminated, that the both-wheel slip determining portion 90a included in the front wheel slip determining portion 90 is eliminated, and that the drive torque calculating portion 94a and the upper limit torque calculating portion 94b included in the coupling control portion 94 are eliminated, as shown in FIG. 13.

The shift control portion 152 controls the operation states of the engagement devices CB disposed in the automatic transmission 18 depending on an amount of acceleration operation by the driver, the vehicle speed V, etc. to selectively form the plurality of gear positions in the automatic transmission 18.

When the coupling protection determining portion 98 determines that at least one of the control couplings 34L, 34R needs to be protected, i.e., when the slip prevention control selecting portion 96 selects the stop of the slip prevention control and the front wheel slip determining portion 90 determines that a slip is occurring on at least one of the left-side and right-side front wheels 14L, 14R while it is determined that the temperature Tcl, Tcr (° C.) of at least one of the left control coupling 34L and the right control coupling 34R estimated by the coupling temperature estimating portion 88 is higher than the predetermined temperature Tc (° C.) defined in advance, the shift control portion 152 releases all the engagement devices CB to bring the automatic transmission 18 into the neutral state in which the power transmission paths are respectively disconnected between the engine 12 and the left-side and right-side front wheels 14L, 14R as well as between the engine 12 and the central axle 48, while the first clutch 24 and the second clutch 32 are respectively engaged. Therefore, when the stop of the slip prevention control is selected, and it is detected that at least one of the left-side and right-side front wheels 14L, 14R has slipped in the four-wheel drive state, the shift control portion 152 brings the automatic transmission 18 into the neutral state.

When the shift control portion 152 brings the automatic transmission 18 into the neutral state, the coupling control portion 94 sets the transmission torques of the left and right control couplings 34L, 34R to zero (Nm).

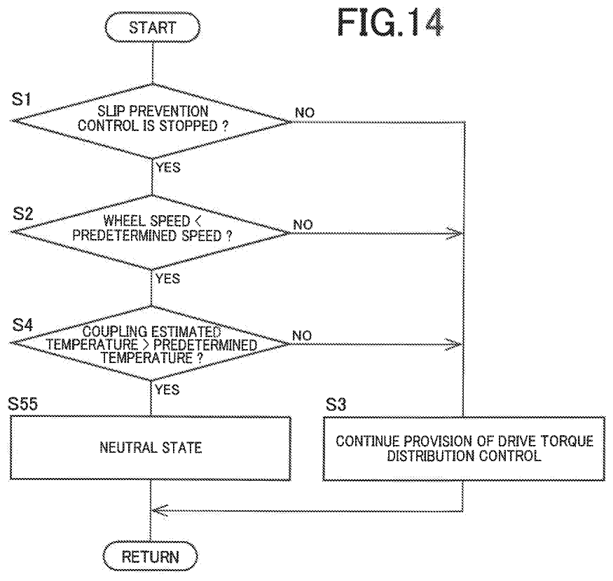

FIG. 14 is a flowchart for explaining an example of control operation in the electronic control device 150 for the left and right control couplings 34L, 34R and the automatic transmission 18 when the vehicle 10 starts in the four-wheel drive state on a road where friction coefficients (μ) are different between the left and right sides of the vehicle 10 as shown in FIG. 3, and both the left-side front wheel 14L and the left-side rear wheel 16L are on the road surfaces RS having relative low friction coefficient μ side slipping. At the start of the flowchart of FIG. 14, as with the start of the flowchart of FIG. 4, the left-side front wheel 14L is slipping, and therefore, the coupling control portion 94 is providing the drive torque distribution control of increasing the transmission torques of the left and right control couplings 34L, 34R so as to increase the rear wheel drive torque transmitted to the rear wheels 16. Since S1 to S4 of FIG. 14 have the same contents as S1 to S4 of FIGS. 4, S1 to S4 of the flowchart of FIG. 14 will not be described.

If the determination of S4 is affirmative, S55 corresponding to the function of the shift control portion 152 is executed, and if the determination of S4 is negative, S3 is executed. At S55, the automatic transmission 18 is brought into the neutral state.

As described above, according to the electronic control device 150 of the four-wheel drive vehicle 10 of this example, when the stop of the slip prevention control is selected, and it is detected that at least one of the front wheels 14 of the left-side and right-side front wheels 14L, 14R has slipped in the four-wheel drive state, the automatic transmission 18 is brought into the neutral state to make the rotation speed Sc of the central axle 48 lower than the rotation speed Sc of the central axle 48 at the time of detection of the slip of the front wheel 14. By making the rotation speed Sc of the central axle 48 lower than the rotation speed Sc of the central axle 48 at the time of detection of the slip of the front wheel 14, the rotation speeds of the input-side friction members are reduced in the left control coupling 34L and the right control coupling 34R, and respective differential rotation speeds become smaller between the input-side friction members and the output-side friction members in the left control coupling 34L and the right control coupling 34R, so that the left control coupling 34L and the right control coupling 34R can be prevented from overheating.

Although the examples of the present invention have been described in detail with reference to the drawings, the present invention can be also applied in other forms.

For example, in the four-wheel drive vehicle 10 of the first example described above, the front wheels 14 are provided with the front-wheel drive power distributing unit 20 serving as a differential device, and the rear wheels 16 are provided with the left and right control couplings 34L, 34R. For example, the structure of the four-wheel drive vehicle 10 may be changed such that the front wheels 14 are provided with the left and right control couplings 34L, 34R, and the rear wheels 16 are provided with the differential device.

In the first to sixth examples described above, when the stop of the slip prevention control is selected, and it is detected that at least one of the front wheels 14 of the left-side and right-side front wheels 14L, 14R has slipped in the four-wheel drive state, the rotation speed Sc of the central axle 48 is made lower than the rotation speed Sc of the central axle 48 at the time of detection of the slip of the front wheel 14 by, for example, operating the brake to the slipping front wheel 14, reducing the drive power of the engine 12, releasing each of the first clutch 24 and the second clutch 32, bringing the automatic transmission 18 into the neutral state, etc. However, the rotation speed Sc of the central axle 48 may be made lower than the rotation speed Se of the central axle 48 at the time of detection of the slip of the front wheel 14 by a method other than those described in the first to sixth examples, for example, by comprising another means of increasing the rotation resistance of the central axle 48.

The coupling protection determining portion 98 included in the electronic control devices 100, 110, 120, 130, 140, and 150 of the examples described above determines whether at least one of the control couplings 34L, 34R needs to be protected when the slip prevention control selecting portion 96 selects the stop of the slip prevention control, the front wheel slip determining portion 90 determines that a slip is occurring on at least one of the left-side and right-side front wheels 14L, 14R, and it is determined that a slower wheel speed between the wheel speed Wrl of the left-side rear wheel 16L and the wheel speed Wrr of the right-side rear wheel 16R is lower than the stop determination speed Wc and thus the vehicle 10 is in a stop state. However, for example, the coupling protection determining portion 98 may determine whether at least one of the control couplings 34L, 34R needs to be protected even when a slower wheel speed between the wheel speed Wrl of the left-side rear wheel 16L and the wheel speed Wrr of the right-side rear wheel 16R is equal to or greater than the stop determination speed We and the vehicle is not in the stop state.

The clutch control portion 132 included in the electronic control devices 130, 140 of the fourth and fifth examples releases both the first clutch 24 and the second clutch 32 when the stop of the slip prevention control is selected and it is detected that at least one of the left-side and right-side front wheels 14L, 14R has slipped in the four-wheel drive state. For example, one of the first clutch 24 and the second clutch 32 may be released.

The above description is merely an embodiment and the present invention can be implemented in variously modified and improved forms based on the knowledge of those skilled in the art.

### REFERENCE SIGNS LIST

10: four-wheel drive vehicle

12: engine (drive power source)

14L: left-side front wheel (main drive wheel)

14R: right-side front wheel (main drive wheel)

16L: left-side rear wheel (sub-drive wheel)

16R: right-side rear wheel (sub-drive wheel)

18: automatic transmission

20: front-wheel drive power distributing unit (differential device)

24: first clutch

28: propeller shaft (power transmitting member)

32: second clutch

34L: left control coupling (control coupling)

34R: right control coupling (control coupling)

48: central axle

90: front wheel slip determining portion

94: coupling control portion

96: slip prevention control selecting portion

100, 110, 120, 130, 140, 150: electronic control device (control device)

102: brake control portion

112: engine output control portion

132: clutch control portion

152: shift control portion

Sc: rotation speed of the central axle

What is claimed is:

1. A control device of a four-wheel drive vehicle that includes a central axle disposed between paired left and right control couplings and coupled to the paired control couplings and that is switched between a two-wheel drive state in which a drive power is transmitted from a drive power source via a differential device to a left-and-right pair of main drive wheels and a four-wheel drive state in which the drive power is also transmitted from the drive power source via the central axle and the paired control couplings to a left-and-right pair of sub-drive wheels, wherein
the control device selects between provision and stop of a slip prevention control in which when at least one main drive wheel of the left-and-right pair of main drive wheels slips during running of the vehicle, a brake is automatically operated to the at least one slipping main drive wheel, and wherein
when the stop of the slip prevention control is selected and it is detected that the at least one main drive wheel of the left-and-right pair of main drive wheels has slipped in the four-wheel drive state, a rotation speed of the central axle is made lower than the rotation speed of the central axle at the time of detection of the slip of the at least one main drive wheel.

2. The control device of a four-wheel drive vehicle according to claim 1, wherein when the stop of the slip prevention control is selected and it is detected that the at least one main drive wheel has slipped in the four-wheel drive state, the brake is operated to the at least one slipping main drive wheel to reduce the rotation speed of the central axle.

3. The control device of a four-wheel drive vehicle according to claim 1, wherein when the stop of the slip prevention control is selected and it is detected that the at least one main drive wheel has slipped in the four-wheel drive state, the drive power output from the drive power source is reduced as compared to the drive power at the time of detection of the slip of the at least one main drive wheel to reduce the rotation speed of the central axle.

4. The control device of a four-wheel drive vehicle according to claim 2, wherein when the stop of the slip prevention control is selected and it is detected that the at least one main drive wheel has slipped in the four-wheel drive state, the drive power output from the drive power source is reduced as compared to the drive power at the time of detection of the slip of the at least one main drive wheel to reduce the rotation speed of the central axle.

5. The control device of a four-wheel drive vehicle according to claim 1, wherein
the vehicle includes a power transmitting member transmitting the drive power output from the drive power source to the central axle in the four-wheel drive state, a first clutch selectively disconnecting or connecting a power transmission path between the drive power source and the power transmitting member, and a second clutch selectively disconnecting or connecting a power transmission path between the power transmitting member and the central axle, and wherein
when the stop of the slip prevention control is selected and it is detected that the at least one main drive wheel of the left-and-right pair of main drive wheels has slipped in the four-wheel drive state, at least one of the first clutch and the second clutch is released to reduce the rotation speed of the central axle,

6. The control device of a four-wheel drive vehicle according to claim 2, wherein
the vehicle includes a power transmitting member transmitting the drive power output from the drive power source to the central axle in the four-wheel drive state, a first clutch selectively disconnecting or connecting a power transmission path between the drive power source and the power transmitting member, and a second clutch selectively disconnecting or connecting a power transmission path between the power transmitting member and the central axle, and wherein
when the stop of the slip prevention control is selected and it is detected that the at least one main drive wheel of the left-and-right pair of main drive wheels has slipped in the four-wheel drive state, at least one of the first clutch and the second clutch is released to reduce the rotation speed of the central axle.

7. The control device of a four-wheel drive vehicle according to claim 1, wherein
the vehicle includes an automatic transmission in a power transmission path between the drive power source and the left-and-right pair of main drive wheels as well as between the drive power source and the central axle, and wherein
when the stop of the slip prevention control is selected and it is detected that the at least one main drive wheel has slipped in the four-wheel drive state, the automatic transmission is brought into a neutral state to reduce the rotation speed of the central axle.

8. The control device of a four-wheel drive vehicle according to claim 1, wherein
when the stop of the slip prevention control is selected and it is detected that the at least one main drive wheel has slipped in the four-wheel drive state, the brake is operated to the at least one slipping main drive wheel to increase a fastening power of at least one of the control couplings depending on an intensity of the brake.
